(19) United States
(12) Patent Application Publication
(10) Pub. No.: US 2002/0195473 A1
(43) Pub. Date: Dec. 26, 2002

(54) Variable width attachment for bicycle rack

(76) Inventor: Guy Fournier, L' Acadie (CA)

Correspondence Address: Guy Fournier, 184 Des Noyers, L' Acadie, QC, J2Y IE7, CA

(21) Appl. No.: 09/886,420

(22) Filed: Jun. 22, 2001

(51) Int. Cl. B60R 9/06

(52) U.S. Cl. 224/502; 224/501; 224/531; 224/924

(57) ABSTRACT

An attachment for a specific type of bicycle rack which allows for the bicycle rack to be attached to the tow bar of a variety of trailers

### BACKGROUND OF THE INVENTION

The invention is an attachment for a specific type of bicycle rack which allows for the bicycle rack to be attached to the tow bar of a variety of trailers. A number of people use their camper trailers to carry their bicycles and so several manufacturers have adapted their bicycle racks for that purpose. Trailer tow bars are usually made up of two steel beams arranged in a triangular configuration with the two ends joining where they are hooked to the hitch ball. Given that the distance between the tow bars varies depending upon the distance from the hitch, if one wants to affix the bikerack at a given position along the tow bar, a specific width will be required. Instead of having a variety of different bikeracks with different widths, it is preferable to have one type of attachment for bicycle rack which will vary its width to fit at any place along the tow bar.

1. Field of the Invention

The invention relates to bicycle racks in general but more particularly to attachments used to interface the bicycle rack proper to the carrying vehicle. Generally, these two components are one and the same but in this particular situation, they form two distinct components.

2. Description of the Relevant Art

A search of the prior art did not specifically reveal any adjustable bicycle rack attachments although there are adjustable hitch attachments such as U.S. Pat. No. 5,511,813 by Kravitz or U.S. Pat. No. 5,149,122 by Helber are, however, quite removed from the invention discussed herein.

### SUMMARY OF THE INVENTION

The purpose of this invention is to provide an attachment for a specific type of bicycle rack which allows for the said bicycle rack to be attached to the tow bars of camper trailers. Since the general configuration of a tow bar is of a triangular shape, the distance between the two steel beams that make up the tow bar changes along its length to the point where they join at the hitch attachment. Sometimes, propane tanks are situated on the tow bar itself, which pushes the bicycle rack installation forward, where the two steel beams are closer together. The variable width attachment, which consists of two offset steel pipes can vary its width by simply turning the two offset pipes in a way that will make them closer together or futher apart. Once the distance between the offset pipes is set, the bicycle rack can be slid onto them and the offset pipes can be tightened.

### DESCRIPTION OF THE DRAWINGS

FIG. 1 Is an isometric view showing the variable width attachment for bicycle rack installed on a tow bar.

FIG. 2 Is an isometric view showing how the couplings engage onto a bicycle rack.

### DETAILED DESCRIPTION OF THE PREFERRED EMBODIMENT

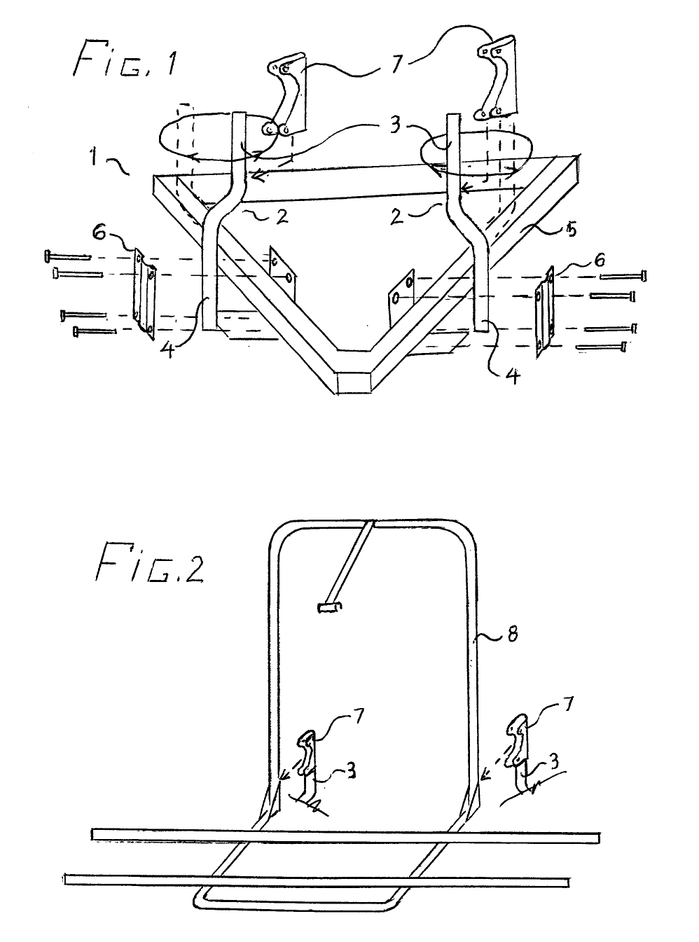

FIG. 1 A variable width attachment for bicycle rack 1 consists of a pair of offset pipes 2 and said pair of offset pipes 2 are further comprised of a top part 3 and a bottom part 4 and said offset pipes 2 are fastened to a tow bar 5 by fastening means 6 which are taken from the group comprised of but not limited to, nuts, bolts and plates. Each of the offset pipes 2 is allowed to rotate in either direction (as indicated by arrows in the ellipses) to affect a change in the distance between the two top parts 3 of the offset pipes 2. Changing the distance between the two said top parts 3 allows for the variable width attachment for bicycle rack 1 to be installed at any point along the tow bar 5. Once the proper width is selected, the offset pipes 2 are tightened so that they can no longer rotate. A pair of couplings 7 each engage one of the two top parts 3.

FIG. 2 The pair of couplings 7 after having engaged the top parts 3 further engage a bicycle rack 8. The couplings 7 are then tightened to secure the bicycle rack 8 onto the top parts 3.

What is claimed is:

1. A variable width attachment for bicycle rack comprised of
a pair of offset pipes comprised of a top part and a bottom part and said offset pipes are rotatably affixed to a trailer tow bar by fastening means which are taken from the group comprised of, but not limited to, nuts, bolts and plates and each of the offset pipes is allowed to rotate in either direction until a preferred distance between the two top parts of the said offset pipes is selected.

2. A variable width attachment for bicycle rack as described in claim 1 is further comprised of
A pair of couplings where each of said couplings engage one of the two top parts of the offset pipes and said pair of couplings, after having engaged the top parts, further engage a bicycle rack.
